(19) United States
(12) Patent Application Publication
(10) Pub. No.: US 2010/0046141 A1
(43) Pub. Date: Feb. 25, 2010

(54) METHOD FOR COATING A POROUS ELECTRICALLY CONDUCTIVE SUPPORT MATERIAL WITH A DIELECTRIC

(75) Inventor: Florian Thomas, Hassloch (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, LUDWIGSHAFEN (DE)

(21) Appl. No.: 12/530,556

(22) PCT Filed: Mar. 12, 2008
(86) PCT No.: PCT/EP08/52895

§ 371 Date: Sep. 9, 2009

(30) Foreign Application Priority Data
Mar. 15, 2007 (EP) 07104185.9

(51) Int. Cl. H01G 4/08; B05D 5/12; B32B 9/04

(52) U.S. Cl. 361/323; 427/58; 428/411.1

(57) ABSTRACT

The invention relates to the production of a coating of a porous electrically conductive support material (1) with a dielectric (18), particularly for use in a capacitor. The production method comprises the steps:
infiltrating the support material (1) with a solution (2) which contains precursor compounds of the dielectric (18) and at least one solvent (12), and which has a boiling temperature T_{S} and a crosslinking temperature T_{N}, and
drying the support material (1) infiltrated with the solution (2) at a drying temperature, which is lower than the boiling temperature T_{S} and lower than the crosslinking temperature T_{N} of the solution (2), until more than 75 wt. % of the solvent (12) is evaporated

The method relates to a method for coating a porous electrically conductive support material with a dielectric and to the use of a coating produced in this way as a dielectric in a capacitor.

The storage of energy in a wide variety of applications is the subject of continuing development work. The progressive miniaturization of electrical and electronic circuits is leading to a demand for fewer and fewer or smaller and smaller components, in order to achieve this storage. For capacitors, therefore, higher and higher capacitance densities are required.

According to the capacitor formulae

E=½C·U² and C=ε·ε₀·A/d,

where E=energy
C=capacitance
U=voltage
ε=dielectric constant of the dielectric
ε₀=permittivity of free space
A=electrode surface area
d=electrode spacing,
   high energy densities can be achieved by using dielectrics with high dielectric constants, as well as by large electrode surface areas and short electrode spacings. The use of dielectrics with a high breakdown voltage is furthermore desirable in order to achieve high operating voltages.

In order to produce ceramic capacitors with a high capacitance density, thin layers of a ceramic material with a high dielectric constant are required. For example oxides with a perovskite structure, for example barium titanate BaTiO₃, are used as ceramic materials.

Very thin films of such materials with film thicknesses of less than 1 μm can be deposited particularly advantageously as solutions. This method is known by the name chemical solution deposition (CSD) or sol-gel deposition, and it is described in detail for example in R. Schwartz: “Chemical Solution Deposition of Ferroelectric Thin Films” in Materials Engineering 28, Chemical Processing of Ceramics, 2^{nd} edition 2005, pages 713 to 742. In this case solutions of the desired elements, usually metal salts or alcoholates, are produced in solvents such as for example alcohols, carboxylic acids, glycol ethers or water. These solutions are applied onto suitable substrates and then thermally decomposed to form the desired material.

For the decomposition, the films are subjected for example to a two-stage heat treatment. First, the organic components are substantially removed by so-called “pyrolysis” at temperatures of from 250 to 400° C. in an air atmosphere. The dissolved inorganic components then crosslink to form an amorphous preceramic material. In the second step, the so-called “calcination” or “crystallization” at temperatures of from 600 to 900° C., the remaining carbon-containing components are broken down and the resulting metal oxide is sintered to form a dense ceramic.

For materials containing barium titanate, a one-stage method is often preferred in which the film is heated directly to the calcination temperature. The high heating rate is regarded as advantageous for the creation of particularly dense films.

The production of ceramic capacitors with a particularly high capacitance density is described, for example, in WO 2006/045520 A1. These capacitors respectively contain a porous electrically conductive support, on as much as possible of whose inner and outer surface a dielectric and an electrically conducting layer are applied. The dielectric is deposited from a solution on the porous support. To this end, the porous support is infiltrated with a solution which contains precursor compounds of the dielectric in a dissolved form, and it is subsequently heat-treated in order to calcine the precursor compounds to form the oxide. The heat treatment is carried out at from 500° C. to 1600° C.

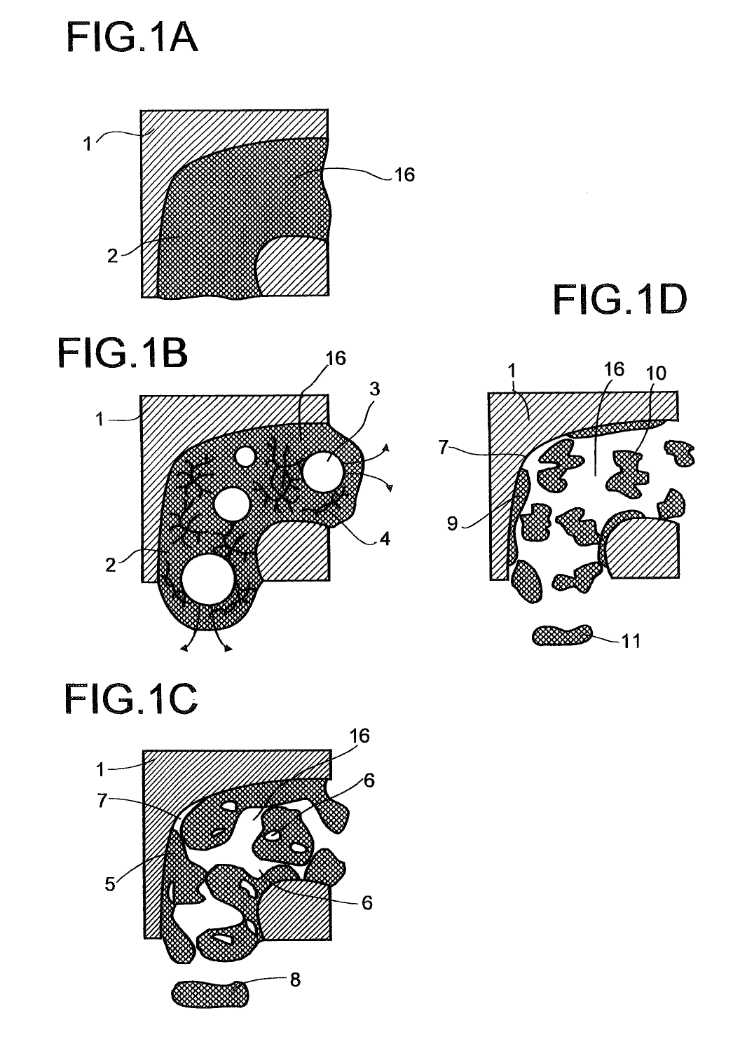

FIGS. 1a to 1d schematically represent the thermal post-treatment according to the prior art.

FIG. 1a shows a detail of the pore space of a support material after infiltration with a coating solution. The pore 16 of the porous support material 1 as represented in this step is entirely filled with a solution 2, which contains precursor compounds of a dielectric and at least one solvent.

FIG. 1b shows the detail according to FIG. 1a during a heat treatment at temperatures which lie above the boiling temperature T_{S} and above the crosslinking temperature T_{N} of the solution. For example, the heat treatment is carried out at temperatures of from 250° C. to 400° C. (“pyrolysis”). During the heat treatment, boiling of the solvent takes place above the boiling temperature T_{S} which depends on the composition of the solution 2. Customary boiling temperatures T_{S} of the solutions 2 used lie in the range of from 80 to 200° C. If the infiltrated porous body is now heated rapidly to above the temperature, then strong boiling takes place while forming bubbles 3 of solvent vapor, which causes the solution 2 to be displaced from the pores 16. Parts of the solution 2 are expelled from the porous support material, and lead to deposition of material 8, 11 outside the support material 1 (see FIGS. 1c and 1d).

This material 8, 11 is lost for the coating, which entails excessive use of solution 2 and the need for frequent repetitions of the coating process to reach the desired coating thickness.

Above the crosslinking temperature T_{N}, which likewise depends on the composition of the solution 2, crosslinking of the dissolved inorganic components furthermore takes place. The crosslinking may entail either the formation of a three-dimensional network structure and therefore gelling of the solution 2, or the growth of particles and therefore precipitation of solid. These reactions are known as “sol-gel methods” in the literature. If this temperature is exceeded before the majority of the volatile components have evaporated, then the crosslinking 4 can take place throughout the volume of the pores 16 since the pores 16 are still mostly filled with the solution 2. This leads to an undesirable nonuniform distribution of the resulting preceramic material and to solidification 5 of material in the interior of the pores 16 (see FIG. 1c).

FIG. 1c shows the detail according to FIGS. 1a and 1b after the heat treatment (pyrolysis). Crosslinking has taken place to form preceramic material 5 in a large part of the pore space 16. The preceramic material 5 contains pores 6 of different size. Some of the preceramic material 5 is in the form of a deposit 8 outside the porous support material.

FIG. 1d shows the detail according to FIGS. 1a, 1b and 1c after a final heat treatment (“calcination”), for example at from 600 to 900° C., by which the coating method is concluded. The walls of the pores 16 comprise uncoated regions 7. The ceramic film 9 covers the pore walls only incompletely. This leads to short circuits during the intended use in a capacitor and therefore to failure of the technical component. Some of the ceramic material remains as particles 10 in the interior of the pores 16. This particulate material 10 is lost for the application as a capacitor, which entails excessive use of coating material and the need for frequent repetitions of the coating process in order to reach the desired coating thickness.

It is an object to the present invention to avoid the disadvantages of the prior art and, in particular, to provide a method for producing a continuous and low-defect coating of a porous electrically conductive support material, with a dielectric.

The coating should as far as possible reach the entire inner and outer surface of the support material, but avoid clogging or unnecessarily filling of the pores. The method should be economical and, in particular, suitable for the production of coatings which can be used in capacitors with a high capacitance density.

It is also an object to provide a coating method which reduces excessive use of coating solution due to deposition of ceramic material in the interior of the pores and outside the pores, and which reduces the risk of short circuits in a technical component by more uniform coating of the pore walls.

The object is achieved according to the invention by a method for coating a porous electrically conductive support material with a dielectric, having the steps:
infiltrating the support material with a solution which contains precursor compounds of the dielectric and at least one solvent, and which has a boiling temperature T_{S} and a crosslinking temperature T_{N}, and
drying the support material infiltrated with the solution at a drying temperature T_{T}, which is lower than the boiling temperature T_{S} and lower than the crosslinking temperature T_{N} of the solution, until more than 75 wt. % of the solvent is evaporated.

It has been found that the disadvantages of the prior art can be avoided by initially treating the porous support material, infiltrated with the coating solution, to dry it at a temperature which is both lower than the boiling temperature T_{S} and lower than the crosslinking temperature T_{N}.

The method according to the invention comprises the infiltration of a porous electrically conductive support material.

The use of electrically conductive support materials furthermore offers the advantage that, owing to the pre-existing electrical conductivity of the support, no additional coating of the support for metallization is necessary. The method therefore becomes simpler and more economical, the capacitors become more robust and are less susceptible to defects.

Suitable support materials preferably have a specific surface (BET surface) of from 0.01 to 10 m²/g, particularly preferably from 0.1 to 5 m²/g.

Such support materials may, for example, be produced from powders having specific surfaces (BET surface) of from 0.01 to 10 m²/g by compression or hot compression at pressures of from 1 to 100 kbar and/or sintering at temperatures of from 500 to 1600° C., preferably from 700 to 1300° C. The compression or sintering is advantageously carried out in an atmosphere consisting of air, inert gas (for example argon or nitrogen) or hydrogen, or mixtures thereof, with an atmosphere pressure of from 0.001 to 10 bar.

The pressure used for the compression and/or the temperature used for the heat treatment depend on the materials being used and on the intended material density. A density of from 30 to 50% of the theoretical value is advantageously desired in order to ensure sufficient mechanical stability of the capacitor for the intended application, together with a sufficient pore fraction for subsequent coating with the dielectric.

To produce the support material, it is possible to use powders of all metals or alloys of metals which have a sufficiently high melting point of preferably at least 900° C., particularly preferably more than 1200° C., and which do not enter into any reactions with the ceramic dielectric during the subsequent processing.

The support material advantageously contains at least one metal, preferably Ni, Cu, Pd, Ag, Cr, Mo, W, Mn or Co and/or at least one metal alloy based thereon.

Advantageously, the support consists entirely of electrically conductive materials.

According to another advantageous variant, the support consists of at least one nonmetallic material in powder form, which is encapsulated by at least one metal or at least one metal alloy as described above. A nonmetallic material which is encapsulated, so that no reactions that lead to a deterioration in the properties of the capacitor take place between the nonmetallic material and the dielectric, is preferred.

Such nonmetallic materials may, for example, be Al₂O₃ or graphite. Nevertheless, SiO₂, TiO₂, ZrO₂, SiC, Si₃N₄ or BN are also suitable. All materials which, owing to their thermal stability, prevent a further reduction of the pore fraction due to sintering of the metallic material during the heat treatment of the dielectric are suitable.

The support materials used according to the invention may have a wide variety of geometries, for example cuboids, plates or cylinders. Such supports can be produced in various dimensions, advantageously of from a few mm to a few dm, and they can therefore be perfectly matched to the relevant application. In particular, the dimensions can be tailored to the required capacitance of the capacitor.

The infiltration of the support material may be carried out by immersing the support in the solution, by pressure impregnation or by spraying it on. Complete wetting of the inner and outer surface of the support material should be ensured in this case.

According to the invention, the support material is infiltrated with a solution which contains precursor compounds of a dielectric and at least one solvent.

All materials conventionally usable as dielectrics may be employed in the present invention.

The dielectric used should have a dielectric constant of more than 100, preferably more than 500.

The dielectric advantageously contains oxide ceramics, preferably of the perovskite type, with a composition that can be characterized by the general formula AₓB_{y}O₃. Here, A and B denote monovalent to hexavalent cations or mixtures thereof, preferably Mg, Ca, Sr, Ba, Y, La, Ti, Zr, V, Nb, Ta, Mo, W, Mn, Zn, Pb or Bi, x denotes number of from 0.9 to 1.1 and y denotes number of from 0.9 to 1.1. A and B in this case differ from each other.

BaTiO₃ is particularly preferably used. Other examples of suitable dielectrics are SrTiO₃, (Ba₁₋ₓSrₓ)TiO₃ and Pb(ZrₓTi₁₋ₓ)O₃, where x denotes number between 0.01 and 0.99.

In order to improve specific properties such as the dielectric constant, resistivity, breakdown strength or long-term stability, the dielectric may also contain dopant elements in the form of their oxides, in concentrations of preferably between 0.01 and 10 atomic %, preferably from 0.05 to 2 atomic %. Examples of suitable dopant elements are elements of the 2^{nd} main group, in particular Mg and Ca, and of the 4^{th} and 5^{th} periods of the subgroups of the periodic table, for example Sc, Y, Ti, Zr, V, Nb, Cr, Mo, W, Mn, Fe, Co, Ni, Cu, Ag and Zn, as well as lanthanides such as La, Ce, Pr, Nd, Sm, Eu, Gd, Tb, Dy, Ho, Er, Tm, Yb and Lu.

According to the invention, the dielectric is deposited on the support from a solution (so-called sol-gel method, also referred to as chemical solution deposition). The provision of a homogeneous solution is particularly advantageous compared with the use of a dispersion, so that clogging of pores and nonuniform coating cannot occur even in the case of sizeable support. To this end, the porous support material is infiltrated with the solution that can be produced by dissolving the corresponding elements or their salts in solvents.

Salts which may be used are for example oxides, hydroxides, carbonates, halides, acetylacetonates or derivatives thereof, carboxylates having the general formula M(R—COO)ₓ with R═H, methyl, ethyl, propyl, butyl or 2-ethylhexyl and x=1, 2, 3, 4, 5 or 6, alcoholates having the general formula M(R—O)ₓ with R=methyl, ethyl, propyl, isopropyl, butyl, sec-butyl, isobutyl, tert-butyl, 2-ethylhexyl, 2-hydroxyethyl, 2-aminoethyl, 2-methoxyethyl, 2-ethoxyethyl, 2-butoxyethyl, 2-hydroxypropyl or 2-methoxypropyl and x=1, 2, 3, 4, 5 or 6, of the elements described above (here denoted as M) or mixtures of these salts. Alcoholates and/or carboxylates of barium and titanium are advantageously used.

Solvents which may preferably used are carboxylic acids having the general formula R—COOH with R═H, methyl, ethyl, propyl, butyl or 2-ethylhexyl, alcohols having the general formula R—OH with R=methyl, ethyl, propyl, isopropyl, butyl, sec-butyl, isobutyl, tert-butyl or 2-ethylhexyl, glycol derivates having the general formula R¹—O—(C₂H₄—O)ₓ—R² with R¹ and R²═H, methyl, ethyl or butyl and x=1, 2, 3 or 4, 1,3-dicarbonyl compounds such as acetylacetone or ethyl acetoacetate, aliphatic or aromatic hydrocarbons, for example pentane, hexane, heptane, benzene, toluene or xylene, ethers such as diethyl ether, dibutyl ether or tetrahydrofuran, or mixtures of these solvents. Glycol ethers, such as methyl glycol or butyl glycol, are particularly preferably used.

According to the invention, the employed solution of the precursor compounds of the dielectric has a concentration of less than 10 wt. %, preferably less than 6 wt. %, particularly preferably from 2 to 6 wt. %, respectively expressed in terms of the contribution of the dielectric to the total weight of the solution. The contribution of the dielectric to the total weight of the solution is calculated as the quantity of material e.g. BaTiO₃ remaining after the calcination, expressed in terms of the quantity of solution used.

The solution, with which the porous electrically conductive support material is infiltrated according to the invention, has a boiling temperature T_{S} and are crosslinking temperature T_{N}, these two temperatures depending on the composition of the solution.

The boiling temperature T_{S} is that temperature at which observable boiling of the solution takes place. This temperature usually corresponds to the boiling temperature of the solution employed to produce the solution. When using solvent mixtures or when dissolved substances are present, the boiling temperature may also be higher or lower than that of the pure solvent. The boiling temperature may be determined by heating the solution in conventional laboratory apparatus, for example in a glass flask with a reflux cooler, until the solution boils under reflux. The boiling temperature is preferably determined under the same atmosphere conditions as those in which the drying process is carried out.

The crosslinking temperature T_{N} is that temperature at which gelling of the solution is to be observed with an increase in its viscosity, or the precipitation of solid from the solution with turbidification. The crosslinking temperature may be determined by heating the solution in conventional laboratory apparatus, for example in a glass flask with a reflux cooler. The crosslinking temperature is preferably determined under the same atmosphere conditions as those in which the drying process is carried out. The solution is preferably heated at a rate of at least 1 K/min, preferably at least 10 K/min, in order to reduce the time required for the heating. If the heating is too slow, crosslinking may take place in the solution at a lower temperature and vitiate the measurement value of the crosslinking temperature. The determination should be carried out with solutions which have preferably been stored for no longer than 30 days. Crosslinking may likewise take place at a lower temperature owing to ageing processes, and vitiate the measurement value of the crosslinking temperature.

According to the invention, the support material impregnated with the solution is dried at a drying temperature T_{T} which is lower than the boiling temperature T_{S} and lower than the crosslinking temperature T_{N} of the solution.

Since this drying process takes place at a temperature T_{T} lower than the boiling temperature T_{S}, no bubbles of solvent vapor are formed. The solvent evaporates only slowly from the surface of the solution. Since the drying temperature is furthermore lower than the crosslinking temperature, crosslinking is furthermore avoided during the drying process. The infiltrated support material is dried at the drying temperature until more than 75 wt. %, preferably more than 90 wt. %, of the solvent contained in the solution has evaporated. The proportion of solvent evaporated may be determined, for example by weighing the support material before and immediately after the infiltration and at regular intervals during the drying process. After the drying process, a layer of dried solution remains inter alia on the pore walls of the support material, the interior of the pores remaining substantially free of coating material.

Inert gases (for example argon, nitrogen), hydrogen, oxygen or water vapor, or mixtures of these gases, may be used as the atmosphere during the drying with an atmosphere pressure of from 0.001 to 10 bar.

When drying in air, contact of the solution with airborne moisture may take place during the drying process. This may possibly accelerate the undesired crosslinking process during the drying, and lower the crosslinking temperature T_{N}. When drying in air, the formation of explosive mixtures may furthermore take place owing to contact of the solvent vapors with the airborne oxygen, which represents a safety risk. It may therefore be advantageous to carry out the drying process in an inert gas atmosphere, for example in nitrogen or argon.

According to a preferred embodiment of the present invention, the drying is carried out at a drying temperature for which the difference of the boiling temperature of the solution minus the drying temperature T_{S}-T_{T} lies between 1 and 40 K, preferably between 10 and 20 K. The drying temperature T_{T} should lie in this temperature range so that the drying process does not take a disadvantageously long time. The drying preferably takes less than 60 min, particularly preferably 10-30 min.

If the crosslinking temperature T_{N} is lower than the boiling temperature T_{S}, then it is advantageous to carry out the drying process at a reduced pressure so as to lower T_{S}. According to a preferred embodiment of the present invention, the drying of the support material infiltrated with the solution is therefore carried out at a reduced pressure relative to standard pressure. The boiling temperature T_{S} of the solution is thereby lowered, possibly to below the crosslinking temperature T_{N}, so that the drying T_{T} temperature can be selected to be as close as possible below the boiling temperature T_{S} and at the same time lies below the crosslinking temperature T_{N}.

As an alternative or in addition, at least one additive which raises the crosslinking temperature T_{N} of the solution may be added to the solution. To this end, additives that can enter into strong coordinative interactions with the dissolved elements may be added to the coating solution. These are usually compounds which, owing to the presence of a plurality of coordinating functional groups, are capable of forming chelate complexes. Examples of such additives are 1,3-diketo compounds, for example acetylacetone or ethyl acetoacetate; 1,2-diols and their ethers, for example methyl glycol or butyl glycol; 1,3-diols and their ethers, for example 1,3-propanediol; 2-aminoethanol and its derivatives; 3-aminoethanol and its derivatives; carboxylates, for example acetates or propionates, diamines such as ethylene diamine.

The at least one additive is preferably at least one compound having the following structure:

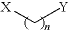

where

n=0, 1, 2 or 3;

X, Y are selected independently of one another from the group consisting of

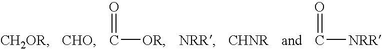

R, R′ are selected independently of one another from the group consisting of H, methyl, ethyl, n-propyl, iso-propyl, n-butyl, i-butyl, sec-butyl and tert.-butyl.

According to another embodiment of the present invention, a thermal post-treatment of the infiltrated and dried support material is carried out after the drying at temperatures between 200 and 600° C., preferably between 250 and 400° C. (pyrolysis). The pyrolysis preferably takes place in an air atmosphere or a water vapor-saturated air or inert gas atmosphere. This thermal post-treatment at from 200 to 600° C. is used to substantially remove the organic components. The dissolved inorganic components are then crosslinked to form an amorphous preceramic material.

According to a preferred embodiment of the present invention, after the drying, a thermal post-treatment of the infiltrated and dried support material is carried out at temperatures between 500 and 1500° C., preferably between 600 and 900° C. (calcination or crystallization). The remaining carbon-containing components are thereby broken down, and the resulting metal oxide is sintered to form a dense ceramic layer on the support material.

Inert gases (for example argon, nitrogen), hydrogen, oxygen or water vapor, or mixtures of these gases, may be used as the atmosphere with an atmosphere pressure of from 0.001 to 10 bar.

In this way, thin films with a thickness of preferably from 5 to 30 nm are obtained over the entire inner and outer surface of the porous support material. As far as possible, the entire inner and outer surface should be covered in order to ensure a maximal capacitance of the capacitor.

After the drying, a two-stage thermal post-treatment may take place (pyrolysis and calcination), or a one-stage thermal post-treatment may be carried out directly (calcination).

According to one embodiment of the present invention, the infiltration, drying and the thermal post-treatment are repeated several times.

In order to adjust the desired layer thickness of preferably from 50 to 500 nm, particularly preferably from 100 to 300 nm, the infiltration and the drying process or the entire coating process (including the thermal post-treatment) are repeated several times if necessary, for example up to 20 times.

There are the following repetition variants:
1. the infiltration and the drying process
2. the infiltration, the drying process and the pyrolysis step at from 200 to 600° C.
3. the infiltration, the drying process, the pyrolysis step and the thermal post-treatment and from 500 to 1500° C.

Variants 2 and 3 are preferred.

In order to save time and energy, the coating need not be fully calcined at a high temperature, for example 800° C., during each repetition. A comparable quality of the coating is achieved even when the coating is initially heat treated only at a low temperature, for example from 200 to 600° C., particularly preferably at about 400° C., and is not fully calcined at a high temperature, as described above, until after all repetitions of the coating process have been completed.

In order to improve the electrical properties of the dielectric, it may be necessary to carry out another heat treatment after the sintering, at a temperature between 200 and 600° C. in an atmosphere having an oxygen content of from 0.01% to 25%.

In one exemplary embodiment the coating of a porous electrically conductive support material with a dielectric, according to the invention, is carried out as follows:

In the conventional way, the precursor compounds of the dielectric which are to be used according to the invention are dissolved in the solvent or solvents simultaneously or successively, or first individually, optionally with cooling or with heating. The production of such solutions has been described in the literature, for example in R. Schwartz “Chemical Solution Deposition of Ferroelectric Thin Films” in Materials Engineering 28, Chemical Processing of Ceramics, 2^{nd} edition 2005, pp. 713-742. Any remaining solid is removed by filtration. Operation is preferably carried out at room temperature. Excess solvent is subsequently distilled off if need be, for example by means of a rotary evaporator, until the desired concentration of the solution has been adjusted. Finally, the solution is preferably filtered in order to remove suspended particles.

The porous shaped bodies are immersed in this solution. A vacuum of from 0.1 to 900 mbar, preferably about 100 mbar, may additionally be applied for 0.5 to 10 min, preferably about 5 min, followed by re-aeration in order to remove trapped air bubbles. The impregnated shaped bodies are removed from the solution and excess solution is dripped off. The shaped bodies are subsequently dried, preferably for 5 to 60 min at from 50 to 200° C., the drying temperature being lower than the crosslinking temperature and the boiling temperature and the time being selected so that more than 75 wt. % of the solvent is evaporated. The shaped bodies are then hydrolyzed for 5 to 60 min at from 300 to 500° C., for example in humid nitrogen. They are finally calcined for 10 to 120 min at the temperatures indicated above, advantageously in dry nitrogen.

The sequence of impregnation/drying/calcination is optionally repeated until the desired layer thickness is reached.

The coatings produced according to the method described above comprise a continuous and low-defect layer of the dielectric on virtually the entire inner and outer surface of the support material.

A coating is low-defect in the context of this invention when the resistivity of the coating is more than 10⁸ Ω·cm, preferably more than 10¹¹ Ω·cm. The resistance of the coating may, for example, be determined by using impedance spectroscopy. With a known specific surface of the support (conventionally determined by BET measurement) and a known layer thickness of the coating (conventionally determined by electron microscopy), the measured resistance can be converted into the resistivity in the manner known to the person skilled in the art.

The coatings according to the invention may be used as a dielectric in a capacitor.

A second electrically conductive second layer is preferably applied as a back electrode on the dielectric. This may be any electrically conductive material conventionally used for this purpose according to the prior art. For example, manganese dioxide or electrically conductive polymers such as polythiophenes, polypyrroles, polyanilines or derivatives of these polymers are used. A better electrical conductivity and therefore lower internal resistance (ESR, equivalent series resistance) of the capacitor is obtained by applying metal layers as the back electrode, for example layers of copper according to DE-A-10325243.

The external contacting of the back electrode may also be carried out by any technique conventionally used for this purpose according to the prior art. For example, the contacting may be carried out by graphitizing, applying conductive silver and/or soldering. The contracted capacitor may subsequently be encapsulated in order to protect it against external effects.

The capacitors produced according to the invention comprise a porous electrically conductive support material, on virtually all of whose inner and outer surface a continuous and low-defect layer of a dielectric and an electrically conductive layer are applied.

The capacitors produced according to the invention exhibit an improved capacitance density compared with the conventional tantalum capacitors or multilayer ceramic capacitors, and they are therefore suitable for the storage of energy in a wide variety of applications, particularly in those which require a high capacitance density. Their production method allows simple and economical production of capacitors having significantly larger dimensions and a correspondingly high capacitance.

Such capacitors may, for example, be used as smoothing or storage capacitors in electrical power engineering, as coupling, filtering or small storage capacitors in microelectronics, as a substitute for secondary batteries, as primary energy storage units for mobile electrical devices, for example electrical power tools, telecommunication applications, portable computers, medical devices, for uninterruptible power supplies, for electrical vehicles, as complementary energy storage units for electrical vehicles or hybrid vehicles, for electrical elevators, and as buffer energy storage units to compensate for power fluctuations of wind, solar, solar thermal or other power plants.

The invention will be explained in more detail below with the aid of the drawing, in which:

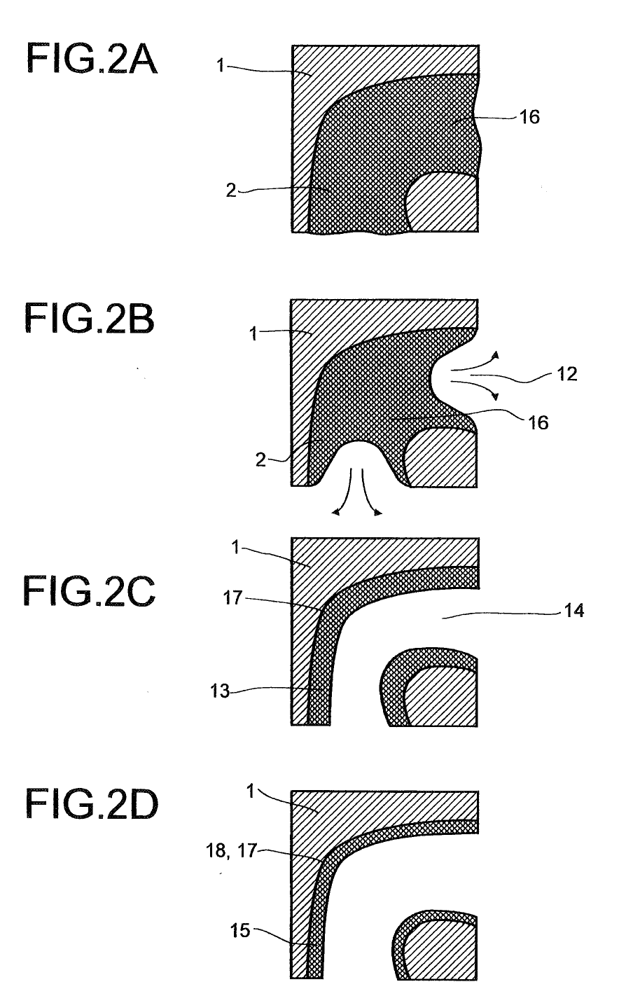

FIGS. 2a to 2d schematically show the conduct of a coating method according to the invention,

FIG. 2a shows a detail of the pore space of a porous electrically conductive support material 1. After infiltration of the support material 1 with a solution 2, which contains precursor compounds of a dielectric and at least one solvent, the pores of the support material 1 (in particular the pore 16 shown) are entirely filled with the solution.

FIG. 2b shows a detail of the pore volume of the support material according to FIG. 2a during the drying. According to the invention, the support material 1 infiltrated with the solution 2 is dried at a drying temperature T_{T} which is lower than the boiling temperature Tₛ and the crosslinking temperature T_{N} of the solution 2. Since the drying process takes place at a temperature T_{T} lower than the boiling temperature T_{S}, no bubbles of solvent vapor are formed. The solvent 12 evaporates only slowly from the surface (from outside the pore 16 inward). According to the invention, the drying at T_{T} takes place until the majority of the solvent 12 contained in the coating solution 2 has evaporated, and preferably until more than 90 wt. % of the solvent 12 has evaporated.

FIG. 2c shows the detail according to FIGS. 2a and 2b after the drying process. In the pore 16, a film of dried coating solution 13 remains on the pore walls 17. The interior for 14 of the pore 16 remains free of coating material.

FIG. 2d shows the detail according to FIGS. 2a to 2c, after a thermal post-treatment of the infiltrated and dried support material 1 has been carried out (calcination at temperatures between 500° C. and 1500°). A continuous film 15 of the ceramic material remains on the pore walls 17 (dielectric 18).

### Examples

An example of a method according to the invention uses a solution having

1 mol barium(II) aminoethylate

0.2 mol 2-aminoethanol

1 mol titanium(IV) butylate

2 mol acetylacetone.

The solution is adjusted to a concentration of 5 wt. %, calculated the basis of BaTiO₃ (the product of the calcination) with the solvent butyl glycol.

The crosslinking temperature T_{N} is 159-160° C.

The boiling temperature Tₛ is 169-171° C.

After infiltration of the support material, i.e. a porous nickel support with a pore fraction of 65% and a specific surface of 0.15 g/m², the samples are dried for 30 minutes at a temperature of 150° C. A uniform pore-free film is obtained.

Further examples are given in the following table.

| | | | | | Drying |
|---|---|---|---|---|---|
| | | | | | temperature |
| Dissolved | | Boiling | Crosslinking | | (at standard |
| components | Solvent | temperature | temperature | | pressure) |
| 1 mol barium(II) | propionic acid | 129-131° C. | 125° | C. | 110° C. |
| propionate | methyl glycol | | | | |
| 1 mol titanium(IV) | mass ratio 1:1 | | | | |
| butylate | | | | | |
| 2 mol acetylacetone | | | | | |
| 1 mol barium(II) | propionic acid | 119-122° C. | 110° | C. | 100° C. |
| propionate | butanol | | | | |
| 1 mol titanium(IV) | mass ratio 1:1 | | | | |
| butylate | | | | | |
| 2 mol acetylacetone | | | | | |
| 1 mol barium(II) | propionic acid | 92-93° C. | >100° | C. | 80° C. |
| propionate | isopropanol | | | | |
| 1 mol titanium(IV) | mass ratio 1:1 | | | | |
| isopropylate | | | | | |
| 2 mol acetylacetone | | | | | |
| 1 mol barium(II) | butyl glycol | 169-171° C. | 159-160° | C. | 150° C. |
| aminoethylate | | | | | |
| 0.2 mol 2-aminoethanol | | | | | |
| 1 mol titanium(IV) | | | | | |
| butylate | | | | | |
| 2 mol acetylacetone | | | | | |

All solutions were adjusted to a concentration of 5 wt. %, calculated on the basis of BaTiO₃ as a calcination product.

### LIST OF REFERENCES

1 porous support material
2 solution
3 bubbles
4 crosslinking
5 solidification of material=preceramic material
6 pores in the solidified material
7 uncoated regions of the pore walls
8 deposit of material
9 ceramic film
10 particle
11 deposit of material
12 solvent
13 dried solution
14 interior of the pore
15 ceramic material
16 pore
17 pore wall
18 dielectric

1: A method for coating a porous electrically conductive support material with a dielectric, comprising:
infiltrating the support material with a solution which contains precursor compounds of the dielectric and at least one solvent, and which has a boiling temperature T_{S} and a crosslinking temperature T_{N}, and
drying the support material infiltrated with the solution at a drying temperature T_{T}, which is lower than the boiling temperature T_{S} and lower than the crosslinking temperature T_{N} of the solution, until more than 75 wt. % of the solvent is evaporated.

2: The method as claimed in claim 1, wherein at least one additive, which raises the crosslinking temperature T_{N} of the solution, is added to the solution.

3: The method as claimed in claim 2, wherein the at least one additive is at least one compound having the following structure: 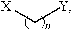
where
n=0, 1, 2 or 3;
X, Y are selected independently of one another from the group consisting of 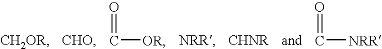
and R, R′ are selected independently of one another from the group consisting of H, methyl, ethyl, n-propyl, iso-propyl, n-butyl, i-butyl, sec-butyl and tert.-butyl.

4: The method as claimed in claim 1, wherein the drying is carried out at a reduced pressure relative to standard pressure.

5: The method as claimed in claim 1, wherein the drying is carried out at a drying temperature for which the difference of the boiling temperature minus the drying temperature of the solution T_{S}-T_{T} lies between 1 and 40 K.

6: The method as claimed in claim 1, wherein after the drying, a thermal post-treatment of the infiltrated and dried support material is carried out at temperatures between 200 and 600° C.

7: The method as claimed in claim 1, wherein a thermal post-treatment of the infiltrated and dried support material is carried out at temperatures between 500 and 1500° C.

8: The method as claimed in claim 6, wherein the infiltration, drying and the thermal post-treatment are repeated several times.

9-10. (canceled)

11: The method as claimed in claim 7, wherein the infiltration, drying and the thermal post-treatment are repeated several times.

12: A coating with a dielectric produced according to the method as claimed in claim 1 used as a dielectric of a capacitor.

13: A capacitor, having a porous electrically conductive support, on the inner and outer surface of which a first layer of a dielectric produced by a method as claimed in claim 1 and a second electrically conductive layer are applied.
